(19) United States
(12) Patent Application Publication
(10) Pub. No.: US 2009/0025471 A1
(43) Pub. Date: Jan. 29, 2009

(54) Air Out Flowing Controller For Cold Waters In Hydraulic Pipeline After The Water Meter

(75) Inventor: Pedro Siqueira, Boca Raton, FL (US)

Correspondence Address: Daniel M. Gurfinkel;Welsh & Katz, Ltd., 120 S. Riverside Plaza, Chicago, IL, 60606, US

(73) Assignee: Airblock Air Controller, LLC, Deerfield Beach, FL (US)

(21) Appl. No.: 12/105,964

(22) Filed: Apr. 18, 2008

(30) Foreign Application Priority Data
Jul. 23, 2007 (BR) 0000220704871006

(51) Int. Cl. G01F 15/00

(52) U.S. Cl. 73/198; 137/2; 73/200

(57) ABSTRACT

Air out flowing controller for cold waters to be installed in hydraulic pipelines, having a body, composed of two parts united, forming a structural component whose purpose is to involve the internal system and its components: The piston whose purpose is to control the air out flowing. The spring works by the pressure differential. The spring will allow the piston to flow of the air with an out flowing inferior than the water meter Q.min.

### FIELD OF THE INVENTION

The present invention concerns a device for controlling flow of air through pipes. More particularly the present invention concerns a device with a purpose to control the air out flowing when it is present in the hydraulic pipeline that supply cold water in order to avoid the air out flowing reading by the water meter without interfering with its mechanism.

### BACKGROUND OF THE INVENTION

The air out flowing controlling function is based on the pressure differential. The air comes to the device with an initial pressure that is interrupted. This pressure is later released under control resulting to a pressure up to 20 times inferior than the initial pressure.

Several factors can contribute to the development of air in the hydraulics pipeline:
Repairs, supply reduction, failure in the pumping system or a simple interruption in the water supply among other reasons. All this air is accounted as water by the water meter which can not distinguish air from water (fluids with different densities), according to the official technical department. The air pressure that arrives to the consumer is approximately 0.3 kgf/cm3 (maximum value) however the air out flowing controller can resist to approximately 0.5 Kgf/cm3, with a variant of 10%.

### SUMMARY OF THE INVENTION

In accordance with the teachings of the present invention, the air out flowing controller device was developed to correct the water meter mechanism deficiency, in such a way that the air out flowing is controlled in order to obtain a value inferior to the Q.min.

The air out flowing controller was designed to be installed only after the water meter. It is coupled to pipes and other hydraulic connections.

It can be manufactured in PVC as well as other non ironed materials. It is manufactured in standard sizes as ½″ (half inch), ¾″ (three quarts), 1″ (one inch), 1¼″ (one and a quart inches), 1½″ (one and a half inches) and 2″ (two inches), according to the ABNT (Brazilian Technical Standards Association) standards and measurements.

A more detailed explanation of the invention is provided in the following description and claims and is illustrated in the accompanying drawings.

### BRIEF DESCRIPTION OF THE DRAWINGS

The drawing presented is in a small tube form.

FIG. 1 is a sectional cut view of a device made in accordance with the present invention.

FIG. 2 is a body sectional cut view with measurements of one preferred embodiment shown thereon.

FIG. 3 is another body sectional cut view with measurements of one preferred embodiment shown thereon.

FIG. 4 is a cross-sectional view of a piston used in the device of the present invention showing measurements for a preferred embodiment thereon.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

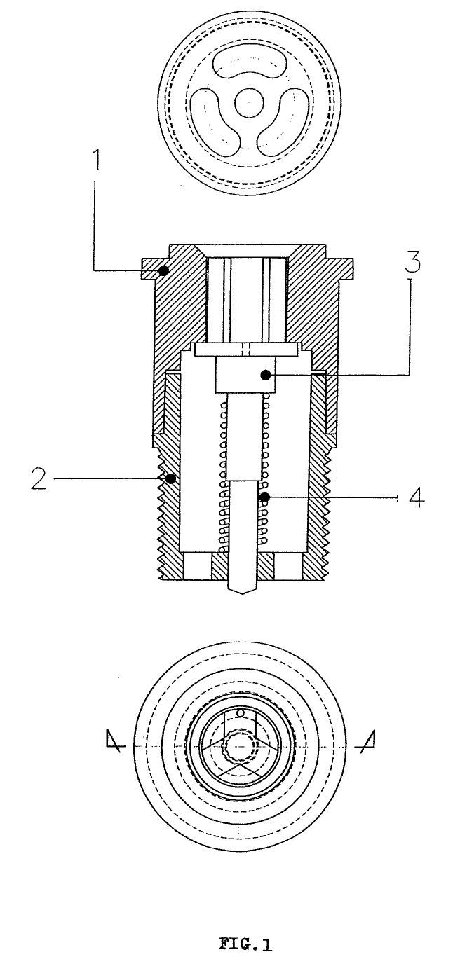

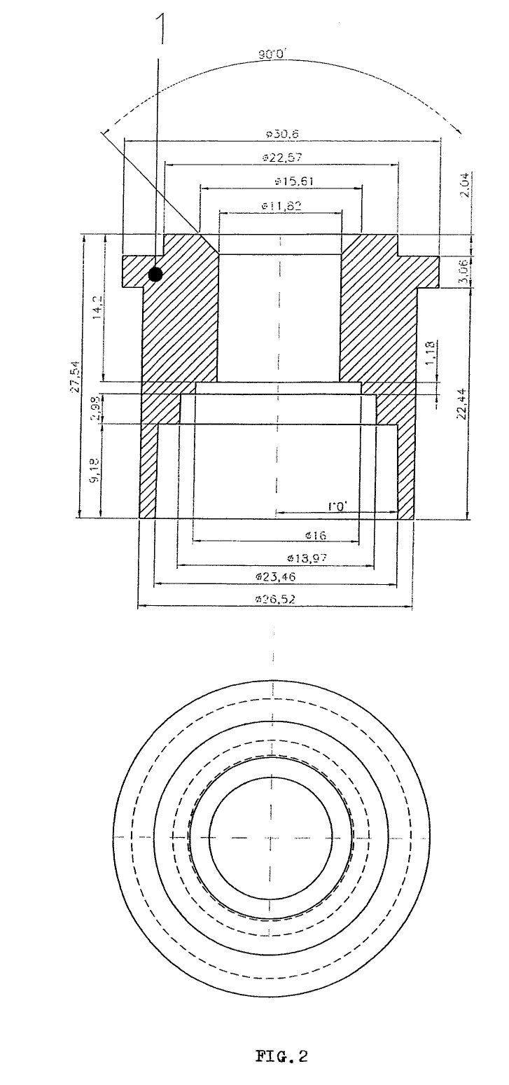

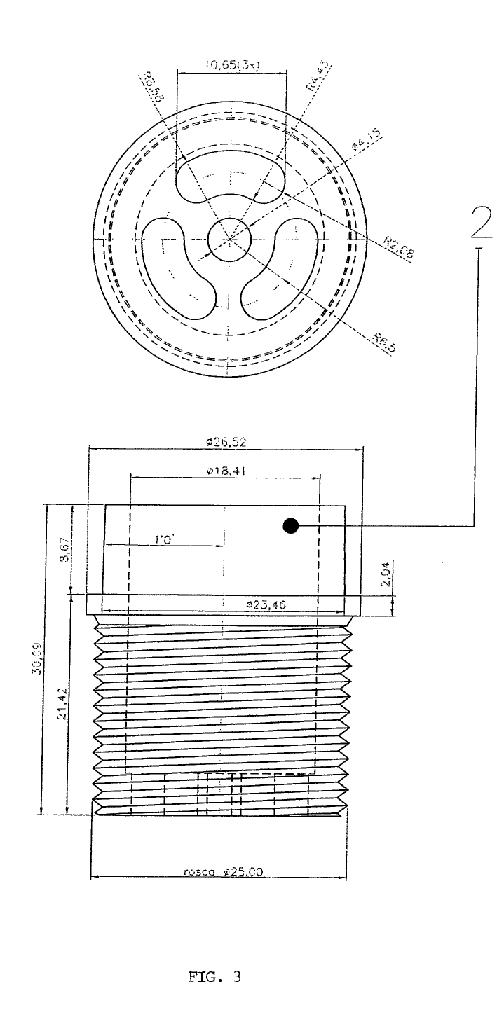

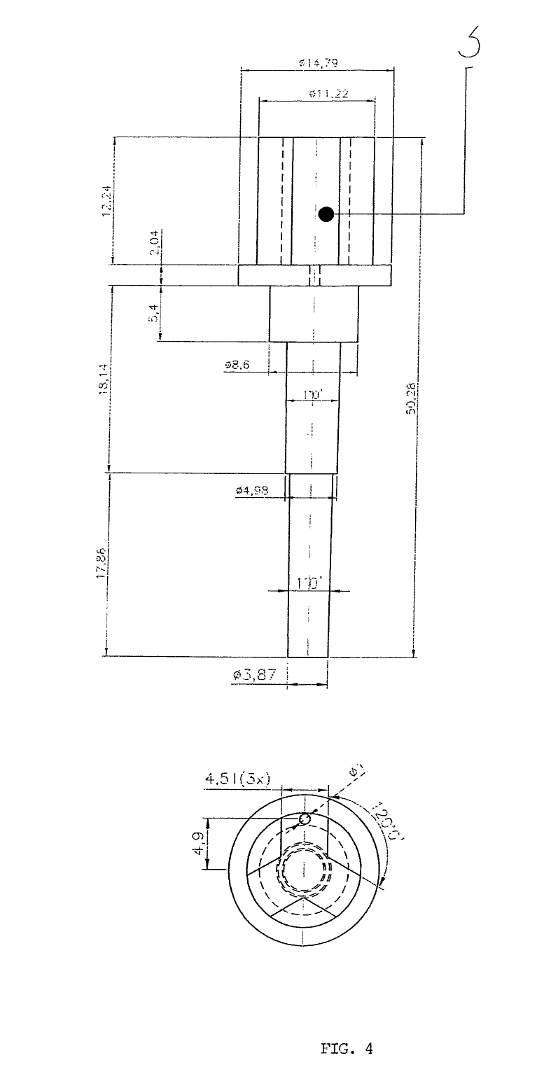

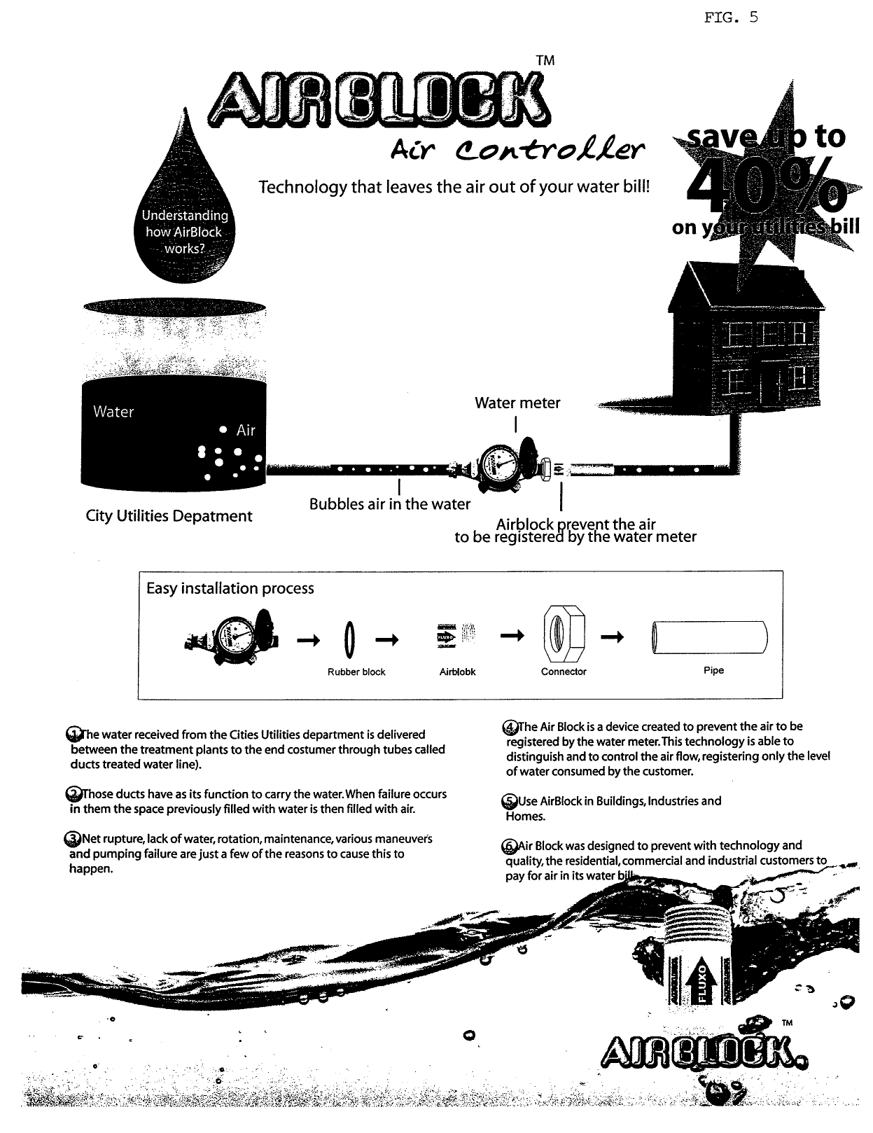

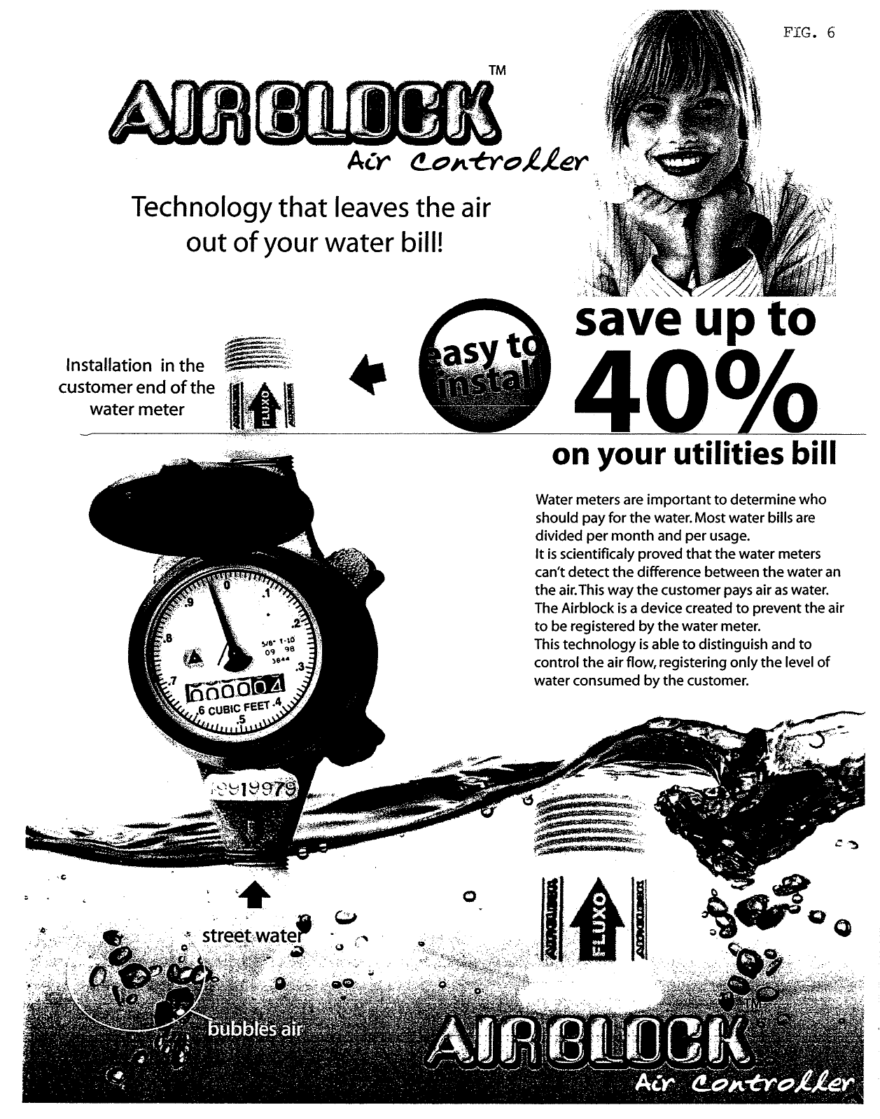

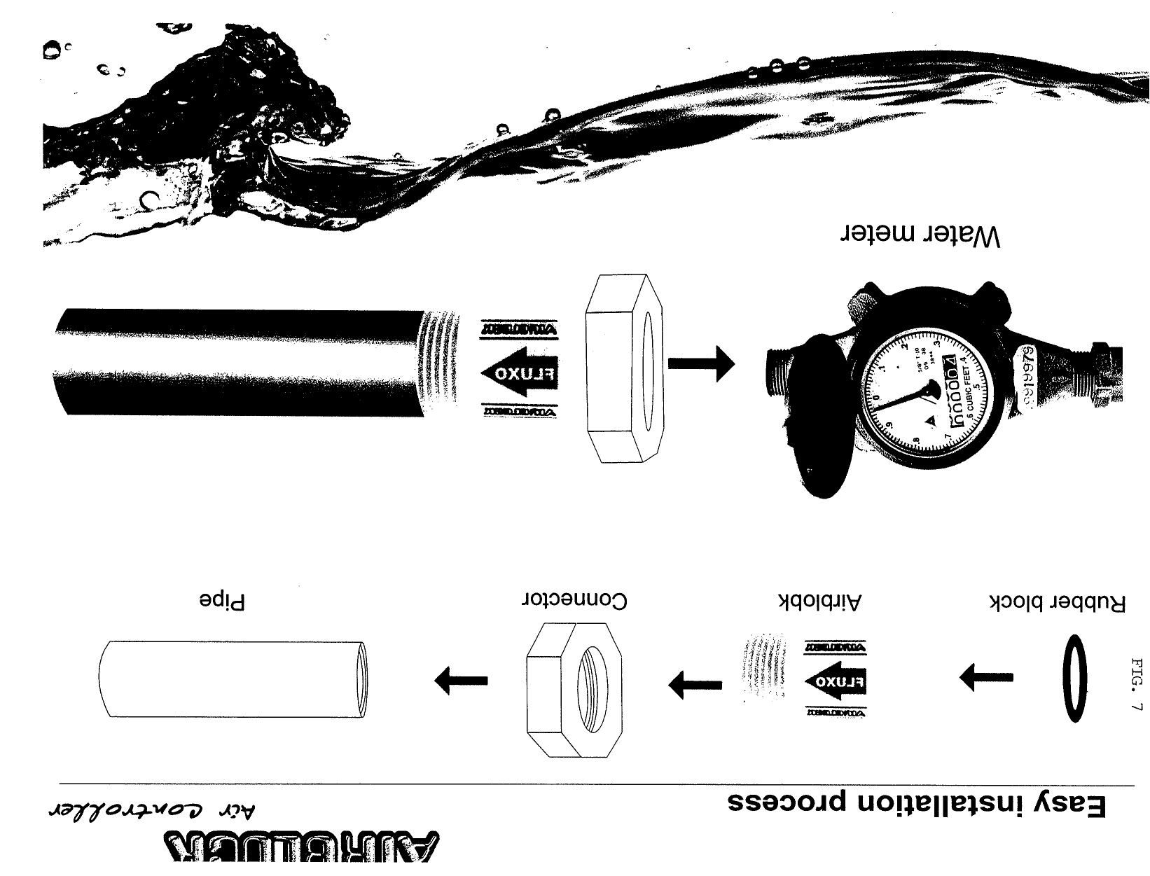

According to the related drawings, the air flowing controller FIG. 1, which is the mounting of the patented object, is composed by the following parts: Body, composed by two pieces see FIGS. 2 and 3 which will be connected forming the body of the controller device. In its interior is located the piston, FIG. 4, which function is to control the air out flowing. In the piston frontal part there is an opening with the function first to control the air out flowing and later this piston will act like a spring, item 4, when is obtain larger air out flowing.

FIG. 2 sectional cut shows the internal and external measurements (according to the ABNT), air and water pass through internally.

FIG. 3 sectional cut shows the internal and external measurements (according to the ABNT), air and water pass through internally.

FIG. 4 shows the piston with its measurements according to FIGS. 2 and 3 for an excellent fit and performance.

FIG. 1—Sectional cut view. It is composed by a body, FIGS. 1 and 2, that united will form the physical structure, it houses a piston, drawing 3, that will control the air out flowing in 2 steps. At the frontal part of the piston there is an opening which allows the air flow—first step, the second step is the spring, drawing 4, that acts in controlling the air out flowing, still in this step the maximum air passing through is obtained.

With this control—characterized by the air passing through the piston opening (3), by the spring system start up (4)—the air out flowing will be modified, resulting in a value smaller than the water meter Q.min. Consequently the water meter reading will only register the passing water.

FIG. 2—Body sectional cut view with its measure. According to the related Figures drawing, the air flowing controller FIG. 1, which is the mounting of the patented object, is composed by the following parts: Body, composed by two pieces see FIGS. 2 and 3 which will be connected forming the body of the controller device. In its interior is located the piston, FIG. 4, which function is to control the air out flowing. In the piston frontal part there is an opening with the function first to control the air out flowing and later this piston will act like a spring, item 4, when is obtain larger air out flowing.

FIG. 2 sectional cut shows the internal and external measurements (according to the ABNT), air and water pass through internally.

FIG. 3—Body sectional cut view with its measure. Sectional cut shows the internal and external measurements (according to the ABNT), air and water pass through internally.

FIG. 4—Piston with its measures. FIG. 4 shows the piston with its measurements according to FIGS. 2 and 3 for an excellent fit and performance.

The piston which purpose is to control the air out flowing. The spring works by the pressure differential. The spring will allow the piston to flow of the air with an out flowing inferior than the water meter Q.min.

What is claimed:

1. It is composed by a body, drawing 1 and 2, that united will form the physical structure, it houses a piston, drawing 3, that will control the air out flowing in 2 steps. At the frontal part of the piston there is an opening which allows the air flow—first step, the second step is the spring, drawing 4, that acts in controlling the air out flowing, still in this step the maximum air passing through is obtained.
With this control—characterized by the air passing through the piston opening (3), by the spring system start up (4)—the air out flowing will be modified, resulting in a value smaller than the water meter Q.min. Consequently the water meter reading will only register the passing water.
